(19) United States
(12) Patent Application Publication
(10) Pub. No.: US 2003/0167200 A1
(43) Pub. Date: Sep. 4, 2003

(54) Indirect brand extension

(76) Inventors: Jeff Reynolds, Kansas City, MO (US); Pat Butler, Shawnee, KS (US); Stan Rice, Lenexa, KS (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/366,967

(22) Filed: Feb. 14, 2003

Related U.S. Application Data
(60) Provisional application No. 60/357,267, filed on Feb. 15, 2002.

(51) Int. Cl. G06F 17/60

(52) U.S. Cl. 705/10

(57) ABSTRACT

Methods and apparatus are provided for measuring the attributes associated with one or more brands, measuring the attributes of one or more business categories, and statistically associating the foregoing to assess the fit between at least one brand and at least one business category. In one embodiment, consumers are surveyed concerning what attributes they associate with a brand, consumers are independently surveyed concerning the attributes that they associate with a product, and the two sets of survey data are statistically associated to determine whether consumers' perceptions concerning a brand fit well with their expectations or perceptions associated with a product.

### CROSS REFERENCE TO RELATED APPLICATION

This application claims priority from U.S. Provisional Application No. 60/357,267, filed Feb. 15, 2002, and titled “Indirect Brand Extension,” which is incorporated by reference in its entirety.

### TECHNICAL FIELD

This description relates to the assessment and statistical association of attributes of brands, products and/or services. In certain embodiments, to surveying consumers concerning brands, products and/or services and statistically associating the survey results to determine the product or service categories into which a brand can be advantageously extended.

### BACKGROUND

Companies often attempt to increase revenue by introducing new or existing products and services into new markets. In the case of consumer products companies, a primary goal is to determine which markets are untapped or incompletely tapped and in which the companies could successfully compete. Fundamental to such an effort is understanding a company's brand identity and determining whether that brand identity will “carry over” to a new market or market segment. Also key to such new business development is comprehending the factors which influence purchases and shopping styles for particular products or services.

In an effort to inform and guide such strategic development decisions, companies often attempt to gauge consumer sentiment by conducting studies aimed at predicting whether a proposed business category will be a “fit,” given the company's reputation, image, and strengths. For example, a company might conduct a survey in which consumers are asked “directly” what they think of the company engaging in a particular business category.

However, with such direct survey techniques, respondents may be predisposed to indicate that the sponsoring company should sell products closely related to those which are already offered by the company. There is an attendant risk that the survey results will not accurately reflect the full range of product or services to which the company's brand identity would usefully extend.

There is a need, therefore, for tools that more accurately measure the fit between a brand and a business category. There is also a need for tools that effectively identify consumer behaviors and attitudes underlying purchases of products or services. It would be advantageous if such tools could effectively predict whether a company's attempt to enter a new market will be hindered or aided by existing consumer sentiments and behaviors associated with the relevant brands, products and services.

### SUMMARY

According to one aspect of the present invention, methods and apparatus are provided for measuring the attributes associated with one or more brands, measuring the attributes of one or more business categories, and statistically associating the foregoing to assess the fit between at least one brand and at least one business category. In one embodiment, consumers are surveyed concerning what attributes they associate with a brand, consumers are independently surveyed concerning the attributes that they associate with a product, and the two sets of survey data are statistically associated to determine whether consumers' perceptions concerning a brand fit well with their expectations or perceptions associated with a product.

According to another aspect of the present invention, methods and apparatus are provided for measuring the fit between a business category and various companies or brands. In various embodiments, survey participants are queried concerning attributes and purchasing experiences associated with a product, participants are separately asked about attributes they associate with a brand or company, and a statistical association is drawn between the product and various brands or companies. The details of these and several additional embodiments of the present invention are set forth in the description below.

Various embodiments of the invention can be implemented to realize one or more of the following advantages. Certain embodiments provide an effective measure of the likelihood that a company can successfully leverage its brand identity in a new market. Some embodiments permit the identification and ranking of new product opportunities in terms of their fit with a selected brand. Various embodiments permit the assessment of the fit between a selected product and various retail distribution channels. Still other embodiments provide a software tool which receives survey data concerning a product or service, receives survey data concerning a brand or company, statistically associates the two data sets, and displays associations that indicate the extent to which, for instance, a brand can be extended to a new market segment. Other features and advantages of the present invention will be apparent from the description and drawings, and from the claims.

### DESCRIPTION OF DRAWINGS

FIG. 1 is a flowchart illustrating an interviewing process for evaluating a business category in accordance with one embodiment of the invention;

FIG. 2 is a flowchart illustrating an interviewing process for evaluating a company/brand in accordance with one embodiment of the invention;

FIG. 3 is a flowchart illustrating a commercial assessment process that implements the processes of FIGS. 1-2;

FIG. 4 is a flowchart illustrating a process for analyzing survey data and assessing brand extensibility;

FIG. 5 is a flowchart illustrating a process for statistically associating survey data; and

FIG. 6 is a diagram of a system adapted to execute a computer program for performing the foregoing processes.

Like reference symbols in the various drawings indicate like elements.

### DETAILED DESCRIPTION OF THE PREFERRED EMBODIMENTS

It has been found that an effective way to gauge the fit between a company or brand and a business category (such as a business solution, product, service or the like) is to utilize an “indirect” measure of fit. This measurement can be used to assess the likelihood that a brand extension can be successfully extended into a new market. Indirect measurement of brand extension can be accomplished by independently measuring the attributes that consumers associate with a brand or company, on the one hand, and the attributes that consumers associate with a business category. The measured attributes can be statistically associated to determine their alignment or association. The closer the association, the better fit the business category for the company brand. For example, a business category can be evaluated against a series of attributes, and then a brand can independently be evaluated against these same attributes. Following this, the data can be evaluated to determine a statistical measure of fit.

In one embodiment, interviews can be conducted with consumers to obtain evaluations of a business category and a company or brand. An architecture can be used as a means to “structure” associations with the brand or category. The structure can be defined to include the consumer needs, values, emotions and characteristics associated with a brand or category.

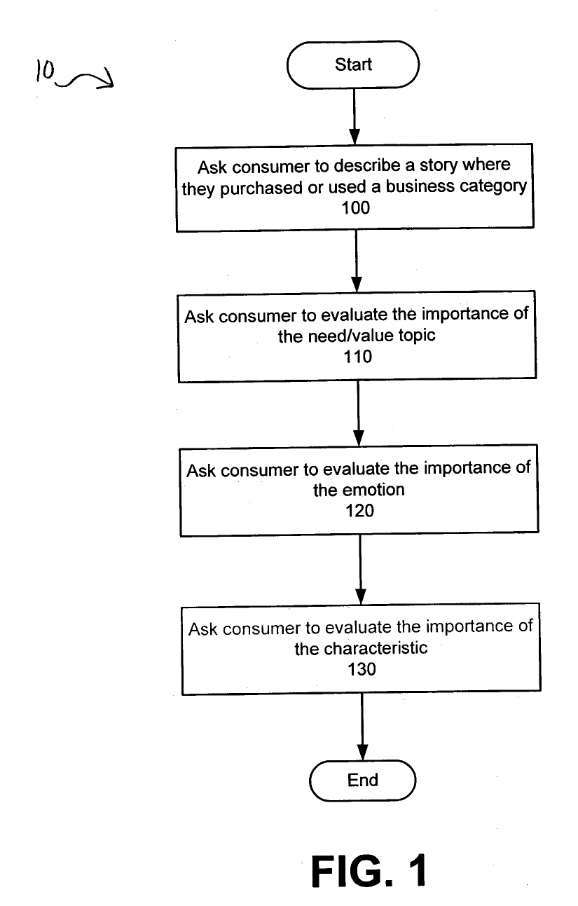

FIG. 1 shows a flowchart for one interviewing process 10 that may be used for evaluating a business category. The process begins, at step 100, with asking a consumer to tell a story about a recent or important occasion where they purchased or used a particular business category (product or service). Stories are used as a means to have consumers focus on past behavior in the context of how and why they use products or services. The question can be intentionally phrased to avoid mentioning any company/brand, so as to elicit a brand- independent response from the consumer concerning the business category.

The respondents may then be asked (110) “In the story you just told me about, how important was (need/value topic)?” Topics can be selected to broadly measure constructs of interest. For instance, topics can be selected to represent needs or values associated with brands, business categories, etc. Topics may relate to attributes of a retail environment and/or product. If consumers readily identify a business category with topics that a company/brand is known and recognized for, the more likely the business category and company/brand will be a “fit.” As an example, a company that prides itself on being associated with creative expression, relationship management, and strong family values and development may consider selected need/value topics relating to “Self,” “Others,” and “Family” appropriate. Need/value topics related to “Self” can include, for example, “learning something new,” “relieving stress,” “feeling like you have accomplished something,” “having fun,” “taking care of your physical health,” and “showing your style.” Need/value topics related to “Others” can include, for example, “having a real friend/genuine friendship,” “being recognized and appreciated,” “having a sense of belonging,” “helping others,” “improving a relationship,” and “remembering the past.” Topics related to “Family” can include, for example, “helping your child learn,” “passing along traditions,” “having a sense of family,” “strengthening your marriage,” and “celebrating important things in life.” The foregoing seventeen need/value criteria, in this example, can be identified as factors that strongly linked businesses with brands.

The respondents next may be asked (120), “In the story you just told me, how much were you feeling (emotion)?” Suitable emotions can include, for example, “a sense of caring,” “sentimental,” “entertained,” “hope,” “contentment,” “excitement,” and “a sense of pride.” These seven emotions have been found to represent a broad cross section of positive emotions.

The respondents can then be asked (130), “How much, in general, do you associate the particular business category with (characteristic)?” Illustrative object characteristics can include, “high quality,” “advanced technology,” “innovation,” “children,” “creativity luxury,” “education,” “exceptional value,” “being inspiring,” and “convenience,” for example.

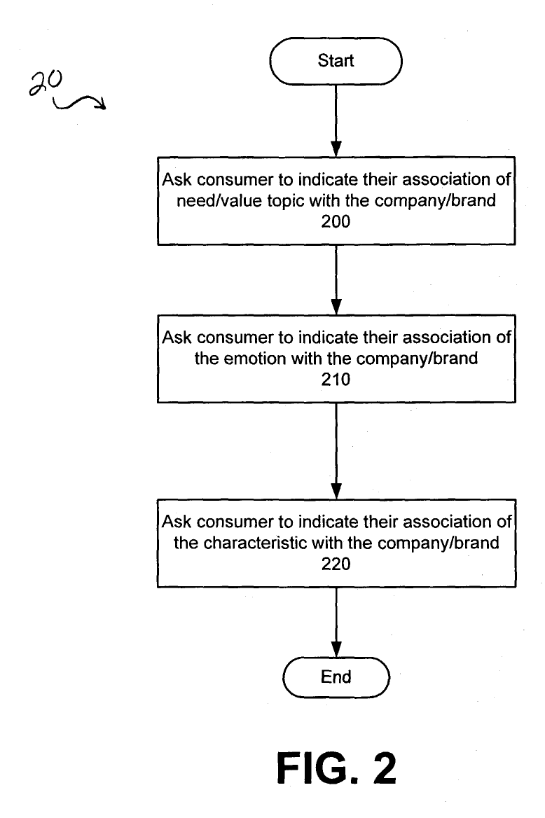

Following this, the respondents may be interviewed again to determine how they associate attributes with the company/brand. FIG. 2 is a flowchart illustrating an interviewing process 20 that can be used for evaluating what attributes consumers associate with a company or brand. The consumer is first asked, in step 200, to indicate their association of the (need/value topic) with the company/brand. Next, the consumer is asked (220) to indicate their association of the (emotion) with the company/brand. Finally, the consumer is asked (230) to indicate their association of the (characteristic) with the company/brand. To facilitate the indirect measure of fit, the same attributes (need/value topics, emotions, and characteristics) described above in the discussion of FIG. 1 can be used. Consumers can also be asked directly about the company's potential within each of the businesses. Alternatively, the participants can also be asked to evaluate associations with an additional competitive brand, or additional attributes or business categories.

The survey responses can be compiled into data collections that can be evaluated to “indirectly” measure associations that bear on the likelihood that a brand can be successfully extended into, for example, a selected target market. More particularly, the survey data can be associated to determine how well a target audience's perceptions with respect to certain features of a product or service related to the audience's perceptions with respect to the company or brand at issue. Statistical associations can be calculated using an algorithm that assesses gaps and statistical associations between the two architectures.

One suitable algorithm for measuring the statistical association between business category (e.g., a product) X and a brand Y is as follows. Let n_{N} equal the total number of need/value attributes (topics), n_{E} equal the total number of emotion attributes, and n_{c} equal the total number of characteristic attributes. Then, n=n_{N}+n_{E}+n_{c}=the total number of attributes. In the illustrative survey technique describe above, n_{N}=17 need/value attributes, n_{E}=7 emotion attributes, and n_{c}=11 characteristic attributes, so n=17+7+11=35 attributes. Now, let mₓ denote the total number of individuals interviewed for business category x, and x_{i,j} be the individual score for person j (j=1, 2, . . . , mₓ) on statement i (i=1, 2, . . . ,n). Then, xᵢ is calculated as the mean for category x, statement i (that is, the sum of the x_{i,j} (j=1, 2, . . . , mₓ) divided by mₓ), x′ is calculated as the global mean across all statements for category x (that is, the sum of the xᵢ (i=1, 2, . . . , n) divided by n), and sₓ is calculated as the sample standard deviation for category x, that is

$${s}_{x} = \sqrt{\frac{{\sum }_{i = 1}^{n} {( {x}_{i} - {x}^{′} )}^{2}}{n - 1}} . \qquad ( 1 )$$

Let Iₓᵢ be an enable function and equal 1 if statement i is to be included in the computations for category x, and equal 0 if not. Define weighting values W_{N}, W_{E}, W_{C} such that each are positive and W_{N}+W_{E}+W_{C}=1 (or 100%). These values allow a user to weight the need/value, emotion, and characteristic attributes more or less heavily, as desired, for the fit calculation. Let Wᵢ equal (W_{N} n/n_{N}) for need/value attributes, (W_{E} n/n_{E}) for emotion attributes, and (W_{C} n/n_{C}) for characteristic attributes.

Applying the same techniques against brand Y, the fit between business category X and brand Y may be measured using equation (2) below:

$${\sum }_{i = 1}^{n} [ ( {W}_{i} ) ( {I}_{xi} ) ( {I}_{yi} ) ( \vert {x}_{i} - {y}_{i} \vert ) {( \frac{{x}_{i} - {x}^{′}}{{s}_{x}} - \frac{{y}_{i} - {y}^{′}}{{s}_{y}} )}^{2} ] \qquad ( 2 )$$

As will be appreciated by those skilled in the art, this statistical association algorithm combines the concept of “straight correlations” (which, in general terms, measure whether values rise or fall together and/or at the same rate) and absolute difference values (which measure the difference between two values, irrespective of whether they rise and fall together).

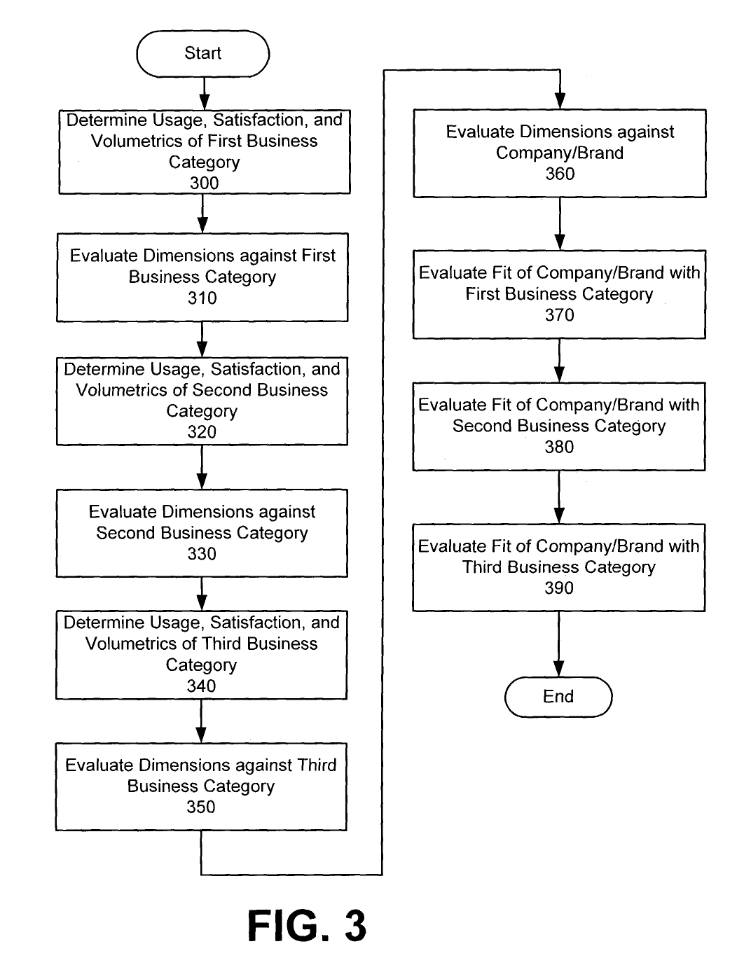

FIG. 3 shows a flowchart illustrating a commercial assessment process that implements the survey and statistical association techniques described above. In this example, three business categories are statistically associated with one company or brand. The process begins, at step 300, with the determination of appropriate usage, satisfaction, and volumetrics for a first business category. In other words, appropriate dimensions (attributes) against which to evaluate the business category are selected. Next, the dimensions are evaluated against the first business category at step 310. Similarly, the steps are repeated for the second business category (steps 320, 330), and third business category (steps 340, 350). The evaluations of steps 310, 330, and 350 can be facilitated by utilizing the FIG. 1 interview process 10. Steps 320 and 340 can be eliminated if the same dimensions are to be evaluated for each business category. Next, at step 360, the dimensions are evaluated against the company/brand. The FIG. 2 interview process 20 can be used, for example, to facilitate this evaluation. If the dimension set against which the business categories were evaluated differs between business categories, the company/brand can be separately evaluated for each dimension set. Next, the fit can be evaluated for the company/brand for the first business category (370), the second business category (380), and the third business category (390).

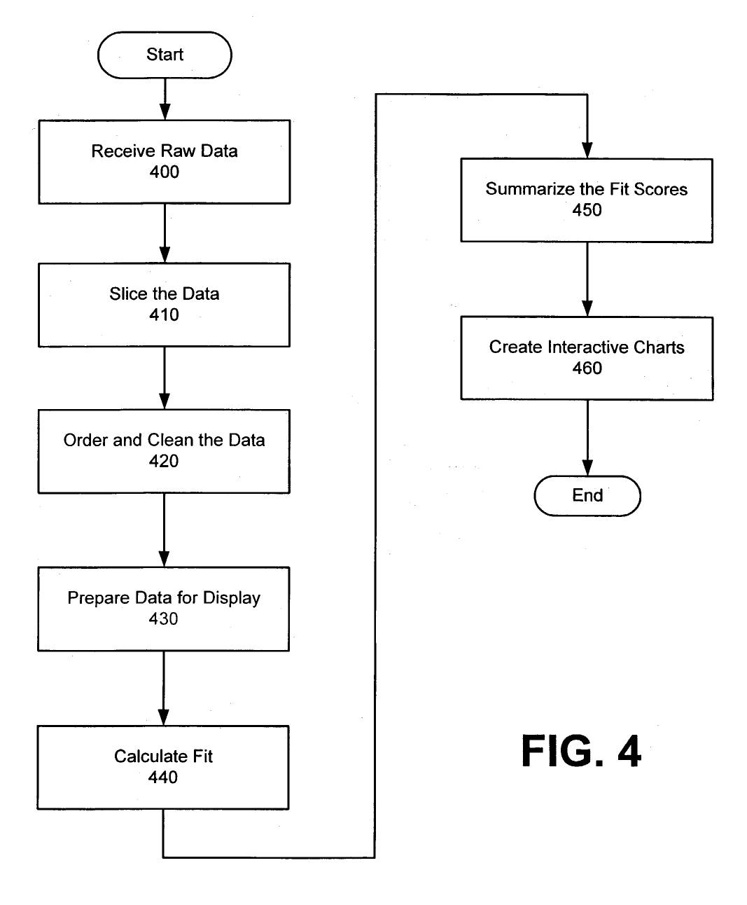

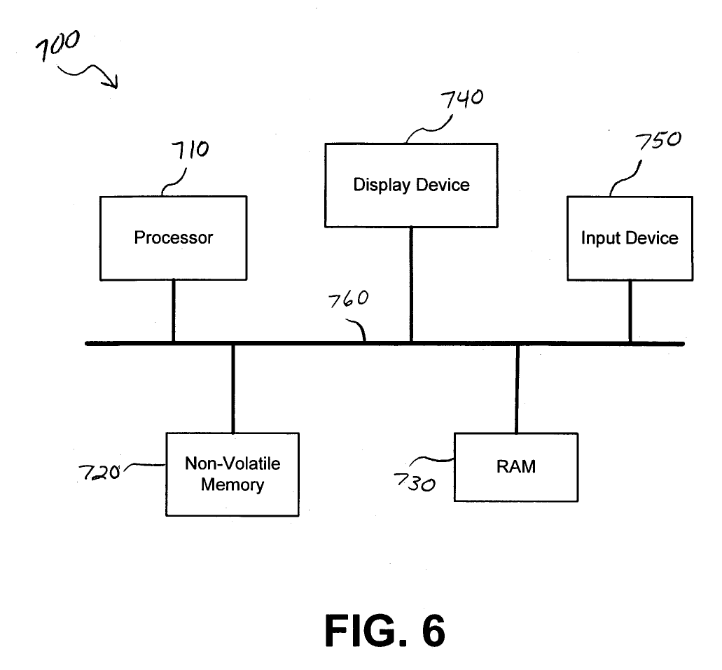

In certain embodiments, it can be advantageous to use a computer program to implement the foregoing techniques. FIG. 4 shows a flowchart that illustrates processes that may be executed, for instance, in the system of FIG. 6. At step 400, raw data is received. This may be the actual raw data from the interview processes 10 and 20 described above. The data may be entered into a spreadsheet application, such as Microsoft Excel. Each step of the process can be presented on a display device to a user as a worksheet in a spreadsheet file, for example. For step 400, the worksheet may be a detailed data worksheet, and in one implementation data can be presented in rows and columns, each row representing a particular interview respondent's assessment of a specific brand or business category and each column representing a question asked during the interview or a demographic/categorical description of the individual. Outlying data can be removed from the worksheet. For example, where respondents are asked to use a 10-point rating scale, but a respondent did not utilize the 10-point scale, instead answering every question with a ‘5.’ Under these circumstances, this individual's data could be removed from the analysis because he or she was clearly not engaged in the process and, therefore, would be detrimental to evaluating brand extension “fit.”

Next, the data may be sliced at step 410. A pivot table in a summary worksheet can be used to tabulate the raw data from detailed data, thereby allowing a user to slice the data by the demographics of those interviewed according to techniques known in the art. For example, the raw data may be sliced by age, gender, occupation, marital status, and/or family status.

The data from the pivot table may be ordered and cleaned (420) after being read into a ‘calculations’ worksheet. Labels specifying the relevant business category or brand can be added to the table, and the columns & rows can be organized and placed in a standard order. In addition, the tabulated & ordered data (which is on a scale from 0 to 10) can be standardized (that is, converted to a normal Gaussian distribution with mean of 0 and standard deviation of 1).

The data can be prepared for display (430) using a ‘data’ worksheet. This sheet can take the item level data from the ‘calculations’ worksheet and prepare it for display in interactive charts (described later). The user is permitted to specify the columns that will be displayed in the charts.

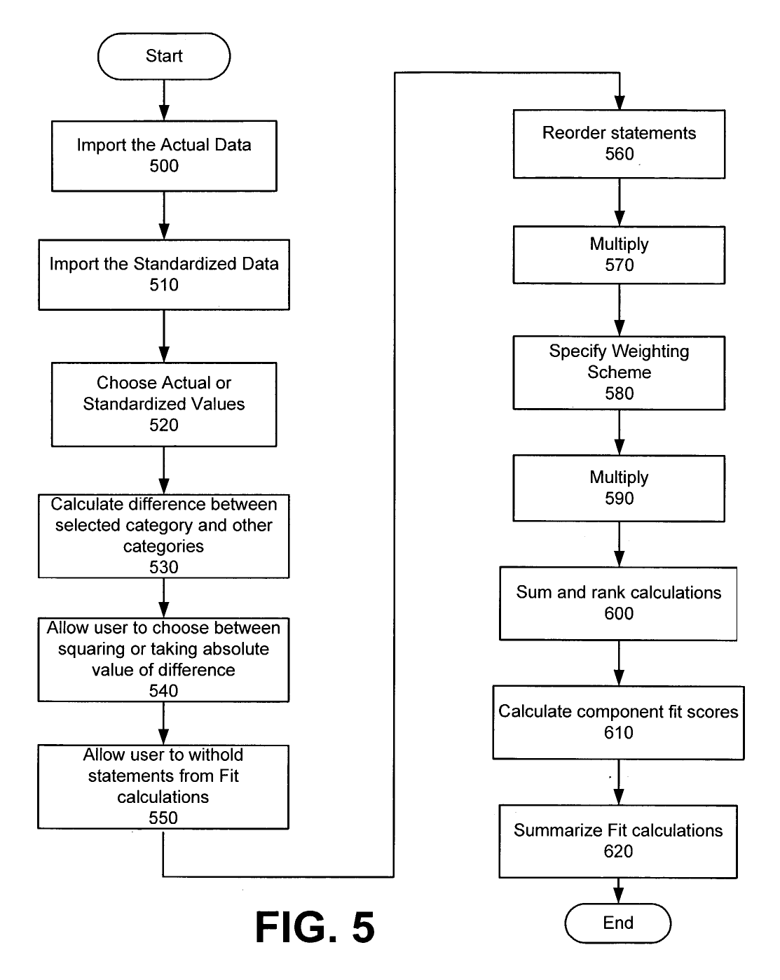

The fit between business categories and brands can be calculated at step 440 using a programmed worksheet. In one embodiment, the computation of fit involves thirteen steps, and is described below in connection with FIG. 5. The worksheet can be programmed to allow the user flexibility in modifying the algorithm for computing fit. For example, a series of drop-down boxes can be coded to specify the available modifications.

The fit scores may be summarized (450) using a ‘method summary’ worksheet. After receiving the fit computations from the ‘completely flexible’ worksheet, the ‘method summary’ worksheet can re-organize them into a user-friendly summary table. For example, categories may be sorted from closest fit to farthest fit and color-coded into close, marginal, and distant groups. This permits repackaging the results without the potentially distracting details from the previous sheet. Interactive charts may be created (460) and presented to the user in a ‘summary’ worksheet. The charts may provide intuitive graphical representations, e.g., bar graphs, line graphs, histograms, pie charts, etc., of various fit measures. Fits of multiple brands against a given business category can be displayed, and/or a given brand can be represented against a group of business categories, if desired. Data tables can be combined with the graphical representations, providing a convenient point of reference to augment the chart(s).

FIG. 5 illustrates a flowchart describing an algorithm useful to perform the Calculate Fit step (440) discussed above. The raw data is imported at step 500, and the standardized data is imported at step 510. Next, a choice can be made between actual and standardized values (520) and then a difference calculated between a selected category and the other categories (530). At step 540, the user is allowed to choose between squaring the difference and taking the absolute value of the difference. Then, the user is given the option of withholding statements from the fit calculation (550), and the statements are reordered (560). Using the selection from step 540 (either square or absolute value of difference) a multiplication step (570) precedes step 580 where the user is allowed to specify a weighting scheme to apply to the attributes. The calculations are then multiplied (step 590) by the specified weights, the calculations are summed and ranked (600), and the component fit scores are calculated (610). Finally, the fit calculations are summarized at step 620.

The computer program described above can be executed on a system such as that depicted in FIG. 6. System 700 includes a processor 710, one or more input devices 750, and a display device 740 whereon a user is presented displays, such as the various worksheets described above, in accordance with an embodiment of the invention. Processor 710 executes instructions of computer programs (such as the program described above), and controls the devices in the computer system 700. The program may initially be stored in non-volatile memory 720, such as ROM, including magnetic disk memory, removable non-volatile storage media, and the like. Program instructions may be loaded to RAM 730, thereafter to be executed by processor 710. A bus 760 facilitates communication between the processor 710 and the various devices attached to the bus 760. A user can use an input device 750, such as a mouse, keyboard, trackball, light pen, etc., to provide input (for example, the raw data input described above) and make selections (such as from a drop-down box) that effect program operation. I/O devices such as a printer (not shown) can be used to print results. Devices such as display controllers, memory controllers, I/O controllers, network adapters, power supplies, etc., are omitted for clarity.

In other embodiments, the techniques described above are used to determine the extensibility of a product into various brands or retail channels. In such embodiments, a survey may be used to collect data concerning consumers' perceptions concerning the attributes associated with a product and/or the purchase thereof. For instance, respondents may be asked to describe experiences involving the purchase of the product. Separate survey questions may be used to collect data concerning the consumer's perceptions concerning attributes associated with various retailers. In our example, respondents may be asked about shopping experiences at various retailers. The statistical association techniques described above may then be used to derive a measure of the extent to which a product ‘fits’ with the environments at various retailers.

In another exemplary embodiment, the tool can used to determine the fit between products and retail environments. In such a circumstance, the survey topics can be selected to characterize attributes associated with both a retail environment and product. Suitable topics could involve needs, atmosphere and emotion. Survey questions in such embodiments would typically be more detailed and specific, to address specific attributes of the retail environments of interest.

Many modifications can be made to the illustrative embodiments set forth above. For instance, there is no need to carry out the correlation with a computer program. Nor is there any restriction concerning the use of Excel—any suitable programming environment will do, including Visual Basic, C, C++, Fortran, Pascal, Java or other known programming languages or environments. The specific formulae set forth above can be freely modified to accommodate variances in the manner in which the study is set up, variances in data (including breadth and reliability of data), desired programming complexity, needed correlative accuracy and precision, etc. For instance, the formulae can be modified so that they simply weight a straight statistical association of two data sets with absolute difference measurements associated with those data sets. The factors addressed during respondent interviews need not be limited to the needs, emotions, characteristics, and attributes set forth above. Any factor or statement considered potentially pertinent can be queried and statistically associated. Virtually any product, service, or the like can be tested to determine its compatibility with any brand or company. Similarly, the techniques set forth herein can be used to determine statistical associations between two or more products or services, two or more brands, two or more companies, or any combination or permutation of the foregoing. Interviews need not be conducted in person, for example, respondents may fill out online or paper surveys or questionnaires, telephone interviews can be conducted, and/or software-based interview methods may be used.

A number of embodiments of the invention have been described. Nevertheless, it will be understood that various modifications may be made without departing from the spirit and scope of the invention. Accordingly, other embodiments are within the scope of the following claims.

What is claimed is:

1. A method of measuring commercial associations, comprising:
receiving a first set of survey data reflecting consumer perceptions concerning a plurality of attributes associated with one or more business categories;
receiving a second set of survey data reflecting consumer perceptions concerning the extent to which substantially the same plurality of attributes are associated with one or more brands;
statistically associating the first and second sets of survey data as a function of the degree to which values in the first set for a given attribute deviate from values in the second set for the same attribute; and
displaying a measure of the fit between one or more business categories and one or more brands according to the result of the statistical association.

2. The method of claim 1, wherein the first set of survey data relates to multiple business categories and the second set of survey data relates to one brand.

3. The method of claim 1, wherein the first set of survey data relates to a single business category and the second set of survey data relates to multiple brands.

4. The method of claim 1, wherein said one or more business categories includes a product, product category, service, or service category.

5. The method of claim 1, wherein the step of statistically associating comprises calculating a measure of fit based at least on averages of survey data for an attribute, standard deviations of survey data for an attribute, and weighting factors which determine the relative influence of each attribute on the measure of fit.

6. The method of claim 2, wherein the step of displaying a measure of the fit comprises indicating the business categories that have the closest statistical association to a brand.

7. The method of claim 3, wherein the step of displaying a measure of the fit comprises indicating the brands that have the closest statistical association to a business category.

8. The method of claim 1, further comprising receiving a user input modifying an equation according to which the statistical association is executed.

9. The method of claim 1, wherein the measure of fit is based on straight correlations and absolute difference values.

10. The method of claim 1, wherein the measure of fit includes a global assessment of fit and an attribute-specific measure of fit.

11. Computer-readable medium with program instructions stored thereon that when executed perform the following functions for measuring commercial associations:
receive a first set of survey data reflecting consumer perceptions concerning a plurality of attributes associated with one or more business categories;
receive a second set of survey data reflecting consumer perceptions concerning the extent to which substantially the same plurality of attributes are associated with one or more brands;
statistically associate the first and second sets of survey data as a function of the degree to which values in the first set for a given attribute deviate from values in the second set for the same attribute; and
display a measure of the fit between one or more business categories and one or more brands according to the result of the statistical association.

12. The medium of claim 11, wherein the first set of survey data relates to multiple business categories and the second set of survey data relates to one brand.

13. The medium of claim 11, wherein the first set of survey data relates to a single business category and the second set of survey data relates to multiple brands.

14. The medium of claim 11, wherein said one or more business categories includes a product, product category, service, or service category.

15. The medium of claim 11, wherein the function of statistically associating comprises calculating a measure of fit based at least on averages of survey data for an attribute, standard deviations of survey data for an attribute, and weighting factors which determine the relative influence of each attribute on the measure of fit.

16. The medium of claim 12, wherein the step of displaying a measure of the fit comprises indicating the business categories that have the closest statistical association to a brand.

17. The medium of claim 13, wherein the function of displaying a measure of the fit comprises indicating the brands that have the closest statistical association to a business category.

18. The medium of claim 11, further comprising instructions that when executed receive a user input modifying an equation according to which the statistical association is executed.

19. The medium of claim 11, wherein the measure of fit is based on straight correlations and absolute difference values.

20. The medium of claim 11, wherein the measure of fit includes a global assessment of fit and an attribute-specific measure of fit.
